(19) United States
(12) Patent Application Publication
(10) Pub. No.: US 2026/0004788 A1
(43) Pub. Date: Jan. 1, 2026

(54) METHOD AND APPARATUS FOR PERFORMING SPEECH ENHANCEMENT, STORAGE MEDIUM, DEVICE, AND PRODUCT

(71) Applicant: TENCENT TECHONOLOGY (SHENZHEN) COMPANY LIMITED, Shenzhen (CN)

(72) Inventors: Weixin ZHU, Shenzhen (CN); Wei RAO, Shenzhen (CN); Yannan WANG, Shenzhen (CN); Yifeng HU, Shenzhen (CN); Defu SHI, Shenzhen (CN); Chenli WAN, Shenzhen (CN); Gaoxiong YI, Shenzhen (CN)

(73) Assignee: TENCENT TECHNOLOGY (SHENZHEN) COMPANY LIMITED, Shenzhen (CN)

(21) Appl. No.: 19/318,576

(22) Filed: Sep. 4, 2025

Related U.S. Application Data
(63) Continuation of application No. PCT/CN2024/105356, filed on Jul. 12, 2024.

(30) Foreign Application Priority Data
Aug. 9, 2023 (CN) 202310999362.5

(51) Int. Cl. G10L 17/20; G10L 17/02; G10L 17/04; G10L 17/06; G10L 17/18; G10L 21/02

(52) U.S. Cl. CPC G10L 17/20; G10L 17/02; G10L 17/04; G10L 17/06; G10L 17/18; G10L 21/02

(57) ABSTRACT

A speech enhancement method, apparatus, and computer-readable storage medium for training neural networks to enhance speech quality. The method obtains a training set containing training samples, each comprising a sample reference speech, a sample comparison speech from the same sound-producing object, and a mixed speech combining interfering human voice, ambient noise, and the sample comparison speech. Sample voiceprint vectors are extracted from reference speech and sample audio features from mixed speech. A speech enhancement network processes these inputs to output predicted audio features, which are compared against comparison audio features to determine training loss values. The network's weight parameters are iteratively updated based on these loss values until training completion, enabling effective speech enhancement through voiceprint-guided processing.

### CROSS-REFERENCE TO RELATED APPLICATIONS

This application is a continuation application of International Application No. PCT/CN2024/105356 filed on Jul. 12, 2024 which claims priority to Chinese Patent Application No. 202310999362.5, filed with the China National Intellectual Property Administration on Aug. 9, 2023, the disclosures of each being incorporated by reference herein in their entireties.

### FIELD

The disclosure relates to the field of artificial intelligence technologies, a method and an apparatus for performing speech enhancement, a storage medium, a computer device, and a computer program product.

### BACKGROUND

Speech enhancement is essentially speech noise reduction. In daily life, a speech collected by a microphone is usually a “polluted” speech with different noise. A main objective of the speech enhancement is to recover a desired clean speech from the “polluted” noisy speech, to effectively suppress various interfering signals and enhance a target speech signal, thereby improving speech audio quality. The speech enhancement is applied in fields including video conference, speech recognition, and the like, and serves as a preprocessing module of many speech coding and recognition systems.

In a complex speech collection environment, in the related art, noise reduction is usually achieved based on a manner of suppressing noise in the collected speech. For example, a speech spectrum may be estimated based on spectral subtraction, noise estimation may be performed by using a Gaussian mixture model, or a spectrum of a clean speech without noise may be learned based on a noise reduction neural network. However, in the related art, an enhanced speech obtained through speech enhancement may be a poor effect. Therefore, how to improve a speech enhancement effect is a technical problem that needs to be resolved urgently in the related art.

### SUMMARY

Provided are a speech enhancement method and apparatus, a device, a storage medium, and a program product, which can implement effective speech enhancement through voiceprint-guided neural network training using mixed audio samples.

According to some embodiments, a speech enhancement method includes: obtaining a training set comprising a plurality of training samples, each of the plurality of training samples comprising a sample reference speech, a sample comparison speech, and a mixed speech obtained by mixing an interfering human voice, ambient noise, and the sample comparison speech, wherein the sample reference speech and the sample comparison speech in a same training sample are from a same sample sound-producing object; extracting a sample voiceprint vector based on the sample reference speech; extracting a sample audio feature based on the mixed speech; performing, based on a speech enhancement network, speech enhancement processing on the sample voiceprint vector and the sample audio feature; outputting a predicted audio feature for the sample sound-producing object based on the speech enhancement processing; determining a training loss value of the speech enhancement network based on the predicted audio feature and a comparison audio feature corresponding to the sample comparison speech; and updating iteratively a weight parameter of the speech enhancement network based on the training loss value until a training ending condition is satisfied.

According to some embodiments, a speech enhancement apparatus, includes: at least one memory configured to store program code; and at least one processor configured to read the program code and operate as instructed by the program code, the program code including: obtaining code configured to cause at least one of the at least one processor to obtain a training set comprising a plurality of training samples, each of the plurality of training samples comprising a sample reference speech, a sample comparison speech, and a mixed speech obtained by mixing an interfering human voice, ambient noise, and the sample comparison speech, wherein the sample reference speech and the sample comparison speech in a same training sample are from a same sample sound-producing object; voiceprint code configured to cause at least one of the at least one processor to extract a sample voiceprint vector based on the sample reference speech; audio code configured to cause at least one of the at least one processor to extract a sample audio feature based on the mixed speech; processing code configured to cause at least one of the at least one processor to perform, based on a speech enhancement network, speech enhancement processing on the sample voiceprint vector and the sample audio feature; outputting code configured to cause at least one of the at least one processor to output a predicted audio feature for the sample sound-producing object based on the speech enhancement processing; determining code configured to cause at least one of the at least one processor to determine a training loss value of the speech enhancement network based on the predicted audio feature and a comparison audio feature corresponding to the sample comparison speech; and updating code configured to cause at least one of the at least one processor to update iteratively a weight parameter of the speech enhancement network based on the training loss value until a training ending condition is satisfied.

According to some embodiments, a non-transitory computer-readable storage medium, storing computer code which, when executed by at least one processor, causes the at least one processor to at least: obtain a training set comprising a plurality of training samples, each of the plurality of training samples comprising a sample reference speech, a sample comparison speech, and a mixed speech obtained by mixing an interfering human voice, ambient noise, and the sample comparison speech, wherein the sample reference speech and the sample comparison speech in a same training sample are from a same sample sound-producing object; extract a sample voiceprint vector based on the sample reference speech; extract a sample audio feature based on the mixed speech; perform, based on a speech enhancement network, speech enhancement processing on the sample voiceprint vector and the sample audio feature; output a predicted audio feature for the sample sound-producing object based on the speech enhancement processing; determine a training loss value of the speech enhancement network based on the predicted audio feature and a comparison audio feature corresponding to the sample comparison speech; and update iteratively a weight parameter of the speech enhancement network based on the training loss value until a training ending condition is satisfied.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a system framework according to some embodiments.

FIG. 2 is a schematic diagram of another system framework according to some embodiments.

FIG. 3 is a schematic flowchart of a method for training a speech enhancement network according to some embodiments.

FIG. 4 is a schematic diagram of an architecture of a speech enhancement network according to some embodiments.

FIG. 5 is a schematic flowchart of a speech enhancement method according to some embodiments.

FIG. 6 is an application scenario diagram according to some embodiments.

FIG. 7 is a flowchart of extracting a target voiceprint vector according to some embodiments.

FIG. 8 is a flowchart of speech enhancement according to some embodiments.

FIG. 9 is a modular block diagram of an apparatus for training a speech enhancement network according to some embodiments.

FIG. 10 is a modular block diagram of a speech enhancement apparatus according to some embodiments.

FIG. 11 is a modular block diagram of a computer device according to some embodiments.

FIG. 12 is a modular block diagram of a computer-readable storage medium according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The following describes implementations of the disclosure in detail. Examples of the implementations are shown in accompanying drawings, and same or similar reference signs in all the accompanying drawings indicate same or similar components or components having same or similar functions. The implementations described below with reference to the accompanying drawings are exemplary and used only for explaining the disclosure, and are not to be construed as a limitation on the disclosure.

In some procedures described in the specification, the claims, and the foregoing accompanying drawings, a plurality of operations occurring in a sequence is included. However, the operations may not be executed in the sequence in which the operations occur in this specification or executed in parallel. Sequence numbers of the operations are merely used to distinguish different operations, and do not indicate any execution sequence. In addition, terms “first”, “second”, and the like in this specification are intended to distinguish between similar objects, but are unnecessarily intended to describe a sequence or order.

In some embodiment, relevant data such as a sample reference speech, a sample comparison speech, an enrollment speech, and a recorded speech are involved. When the relevant data is applied to products or technologies in some embodiments, permission or consent of a user may be obtained, collection, use, and processing of the relevant data need to comply with relevant laws, regulations, and standards of relevant countries and regions, and subsequent data use and processing activities are carried out within the scope of laws, regulations, and the authorization of a personal information subject.

A method for training a speech enhancement network provided in the disclosure relates to an artificial intelligence (AI) technology, and the speech enhancement network is configured for performing speech processing. Key technologies of a speech technology include an automatic speech recognition (ASR) technology, a text to speech (TTS) technology, and a voiceprint recognition (VPR) technology. To make a computer capable of listening, seeing, speaking, and feeling is a future development direction of human-computer interaction. In some embodiments, based on a speech enhancement technology during speech processing, voiceprint extraction of a speaker may be performed on a collected speech and noise reduction is performed on noise of the speech.

Currently, in the related art, noise reduction is usually achieved based on a manner of suppressing noise in the collected speech. For example, a speech enhancement method based on spectral subtraction uses a feature that additive noise is not correlated to a speech. On the premise that it is assumed that statistics on noise are stationary, an estimated value of a noise spectrum obtained by measurement of a non-speech segment is replaced with a spectrum of noise during speech, and is subtracted from a spectrum of a speech including noise, to obtain an estimated value of a speech spectrum.

In a Gaussian mixture model (GMM)-based speech enhancement method, a GMM is used to estimate background noise and a spectral subtraction coefficient, and spectral subtraction is performed on a noisy speech, to recover a pure speech. The noisy speech is preprocessed to obtain a corresponding amplitude and phase, the amplitude is configured for noise estimation and spectral subtraction, and the phase is configured for recovering a time-domain signal. Further, a noise parameter and a pure speech cepstral feature are estimated in real time from the noisy speech by using the GMM, a spectral subtraction coefficient is calculated based on the estimated pure speech cepstral feature, and then spectral subtraction is performed on a spectrum of the noisy speech, to recover the time-domain signal to obtain the enhanced speech.

In a deep neural network (DNN)-based speech enhancement method, a noisy speech spectrum is inputted into a deep neural network, for example, a recurrent neural network (RNN) or a convolutional neural network (CNN). A learning objective for network training is to obtain a clean speech spectrum. The collected speech is inputted into the enhancement network obtained through training, so that the enhancement network can directly output a speech spectrum from which stationary noise and non-stationary noise are effectively suppressed. However, the foregoing speech enhancement method cannot suppress a background interfering human voice in the collected speech, and speech enhancement has low quality. To resolve the foregoing problem, the inventor, through studies, provides a method for training a speech enhancement network according to some embodiments.

The following first describes a system architecture of the method for training a speech enhancement network involved in the disclosure.

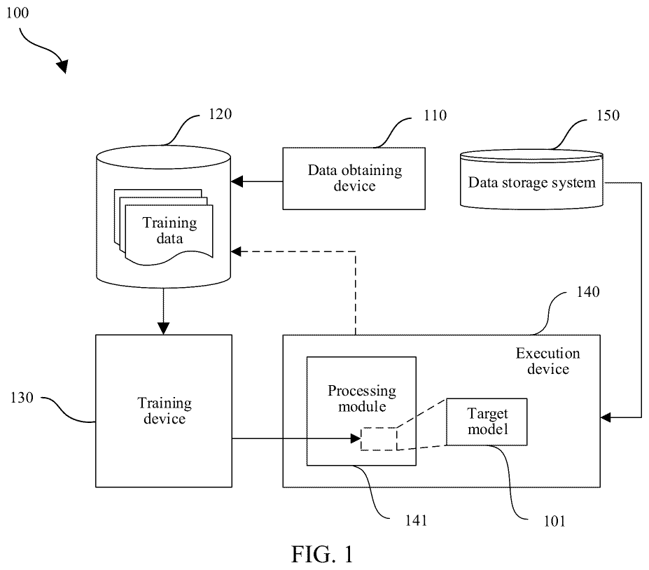

As shown in FIG. 1, the method for training a speech enhancement network according to some embodiments may be applied to a system 100. The system 100 may be configured for model training. A data obtaining device 110 is configured to obtain a training set, and the training set includes a plurality of training samples. For the method for training a speech enhancement network in some embodiments, each training sample may include a sample reference speech, a sample comparison speech, and a mixed speech. The sample reference speech and the sample comparison speech in a same training sample are from a same sample sound-producing object. The training set may be configured for training a target model 101 that performs speech enhancement on a collected user speech. After obtaining training data, a data obtaining device 110 may store the training data in a database 120, and a training device 130 may obtain the target model 101 through training based on the training set maintained in the database 120.

Specifically, the training device 130 may train a preset speech enhancement network based on inputted training data until the speech enhancement network satisfies a preset training ending condition, to obtain a trained target model 101, for example, the speech enhancement network in the disclosure. The training ending condition may be: A loss value of a target loss function (for example, a training loss value) is less than a preset value, a loss value of a target loss function (for example, a training loss value) does not change any more, a quantity of times of training reaches a preset quantity of times, or the like. The target model 101 may be configured to automatically perform speech enhancement based on an inputted voiceprint vector and speech audio feature of a target user (which is referred to as a target sound-producing object in the disclosure), to obtain an enhanced audio feature of the target sound-producing object. A processing process involved in the target model 101 may include audio feature extraction and the like. The target model 101 in some embodiments may be a deep neural network (DNN). A network structure may include a long short-term memory (LSTM), a fully connected layer, a convolutional neural network (CNN), and the like. This is not limited herein.

In an actual application scenario, the training data maintained in the database 120 is not necessarily all obtained by the data obtaining device 110, and may be received from another device. For example, an execution device 140 may alternatively be used as a data obtaining end, use the obtained data as new training data, and store the new training data in the database 120. In addition, the training device 130 may not necessarily train a preset neural network entirely based on the training data maintained in the database 120, or may train a preset neural network based on training data obtained from a cloud or another device. For example, when the execution device 140 is a terminal in which a client is located, the collected user speech may be used as the training data. The foregoing descriptions are not to be construed as a limitation on some embodiments.

The foregoing target model 101 obtained through training based on the training device 130 may be used in different systems or devices, for example, used in the execution device 140 shown in FIG. 1. The training device 130 and the execution device 140 may be servers, terminals, or the like. The server may be an independent physical server, or may be a server cluster including a plurality of physical servers or a distributed system, or may be a cloud server providing cloud computing services, such as a cloud service, a cloud database, cloud computing, a cloud function, cloud storage, a network service, cloud communication, a middleware service, a domain name service, a security service, a content delivery network (CDN), blockchain, big data, and an artificial intelligence platform. The terminal may be a smartphone, a tablet computer, a notebook computer, a desktop computer, or the like.

In a process in which a processing module 141 of the execution device 140 executes computing, the execution device 140 may invoke data, programs, and the like in a data storage system 150 for corresponding computing processing, and may store data and instructions such as processing results obtained through the computing processing in the data storage system 150. The training device 130 may generate, based on different training data, corresponding target models 101 for different purposes or different tasks. The corresponding target model 101 may be used to complete a training task of the corresponding speech enhancement network and a speech enhancement task that is performed by using the speech enhancement network.

For example, the training device 130 in the system 100 shown in FIG. 1 may be a cloud server deployed by a service provider, and the execution device 140 may be a terminal (for example, a smartphone) used by a user. The cloud server may perform network training based on the training set to obtain a speech enhancement network configured for executing a speech enhancement task. The speech enhancement network may include a first long short-term memory sub-network and a first fully connected sub-network. Further, the terminal may implement training to obtain the speech enhancement network, for example, the target model 101 executes the speech enhancement task.

For example, in a video conference scenario, when a speaker in a conference speaks, a video conference client in the conference may perform speech enhancement on a collected spoken speech of the speaker based on the method of the disclosure. Specifically, the client may obtain a voiceprint vector of the speaker, and input the voiceprint vector and an audio feature of the spoken speech into the speech enhancement network. Further, the speech enhancement network may output, for the speaker, a clean speech feature after noise reduction, and perform speech reconstruction on the clean speech feature to obtain a corresponding clean speech after noise reduction, so as to send the clean speech to another conference for playback.

FIG. 1 is only a schematic diagram of an architecture of a system according to some embodiments. The architecture of the system and application scenarios described in some embodiments are intended to more clearly illustrate the technical solutions of some embodiments, and do not constitute a limitation on the technical solutions provided in some embodiments. For example, in another case, the training device 130 in FIG. 1 may alternatively be a terminal. The execution device 140 may alternatively be a cloud server deployed by a service provider.

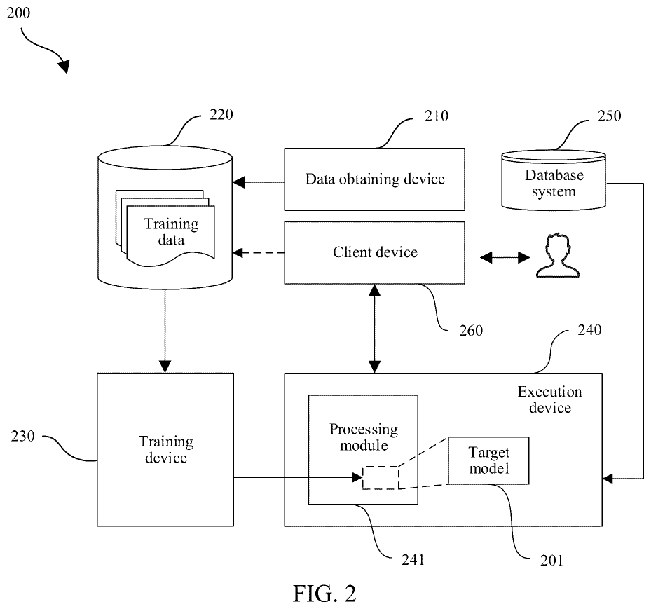

As shown in FIG. 2, the method for training a speech enhancement network according to some embodiments may also be applied to a system 200. For example, functions and application scenarios of a data obtaining device 210, a database 220, a training device 230, and a database system 250 in the system 200 may be correspondingly the same as those of the data obtaining device 110, the database 120, the training device 130, and the database system 150 in the system 100. An execution device 240 in the system 200 may be a cloud execution server. The cloud execution server deploys a speech enhancement network obtained through training by a cloud training server (for example, the training device 230), and can run the speech enhancement network and a client device 260 to cooperatively execute a speech enhancement task. In a possible embodiment, as shown in FIG. 2, the execution device 240 may include a processing module 241. The processing module 241 can perform speech enhancement processing on the collected user speech by using a target model 201, to complete the speech enhancement task.

For example, the user may install and use an audio sharing client on the notebook computer (for example, the client device 260). When the user uses a broadcast function of the audio sharing client on the audio sharing client, the notebook computer may send, to the cloud execution server by using the network, an on-site speech collected when the user uses the broadcast function. Further, when receiving the on-site speech, the cloud execution server uses the speech enhancement network to perform speech enhancement based on the voiceprint vector of the user and an audio feature of the on-site speech, and outputs the clean speech after noise reduction. Further, the cloud execution server may send the clean speech to the audio sharing client of the user listening to the broadcast.

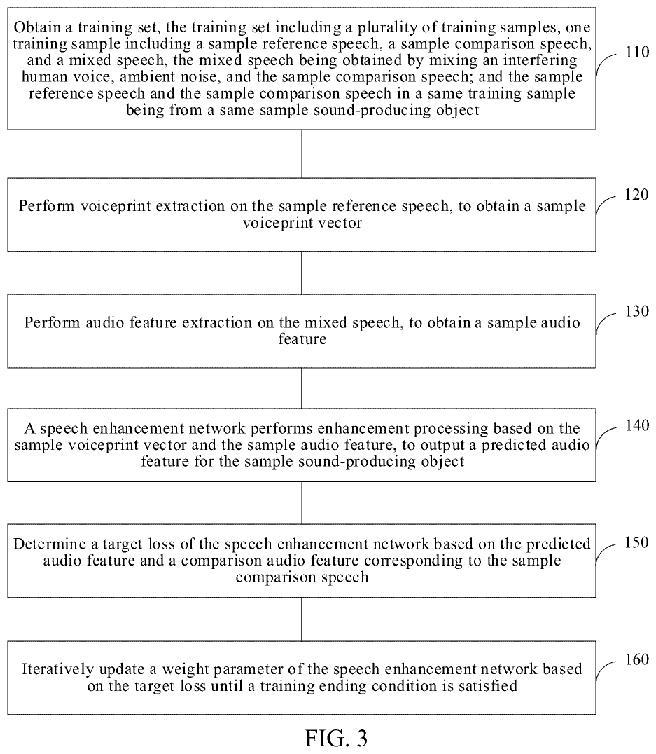

FIG. 3 is a schematic flowchart of a method for training a speech enhancement network according to some embodiments. In some embodiments, the method for training a speech enhancement network may be performed by a server, and the server has at least storage, computing, and communication functions. As shown in FIG. 3, the method for training a speech enhancement network may include the following operations.

Operation S110: Obtain a training set, the training set including a plurality of training samples, one training sample including a sample reference speech, a sample comparison speech, and a mixed speech, the mixed speech being obtained by mixing an interfering human voice, ambient noise, and the sample comparison speech; and the sample reference speech and the sample comparison speech in a same training sample being from a same sample sound-producing object.

In a use scenario of a speech enhancement technology, a to-be-enhanced speech on which speech enhancement may be performed usually includes an interfering human voice. For example, in addition to ambient noise, a speech sound of a classmate collected by an online class client may further include speech sounds of other classmates, for example, the interfering human voice. In consideration that the interfering human voice cannot be effectively suppressed in a speech enhancement process in the related art, the disclosure provides training of a speech enhancement network based on a sample reference speech and a sample comparison speech that have a same sample sound-producing object, so as to use a trained speech enhancement network to perform, on a to-be-enhanced speech, speech enhancement that can suppress the interfering human voice.

In some embodiments, each training sample may include the sample reference speech, the sample comparison speech (for example, a clean speech), and the mixed speech. The mixed speech may be obtained by mixing the interfering human voice, the ambient noise, and the sample comparison speech in different proportions. In some embodiments, the mixed speech may be obtained according to the following formula:

$${S}_{mix} = α {S}_{1} + β {S}_{2} + γ {S}_{3}$$

where Sₘᵢₓ represents a mixed speech, S₁ represents an interfering human voice, S₂ represents ambient noise, and S₃ represents a sample comparison speech. α, β, γ are proportion parameters, and α, β, γ∈(0,1). In a same training sample, a sound-producing object of a sample reference speech and a sound-producing object of a sample comparison speech are a same person, and the sound-producing object of the sample reference speech and the sound-producing object of the sample comparison speech and a sound-producing object of the interfering human voice are different persons.

In some embodiments, the sample reference speech and the sample comparison speech in the training sample may be a speech recorded by the sample sound-producing object. In some embodiments, an objective of training the speech enhancement network may be to make a speech audio feature predicted by the network based on the sample reference speech and an audio feature of a real speech (for example, the sample comparison speech) as close as possible. It may be set that duration of the sample reference speech and duration of the sample comparison speech need to satisfy a duration threshold range. The duration threshold range is configured for ensuring that duration of the sample reference speech and the sample comparison speech is long, thereby ensuring that accurate features can be extracted from the sample reference speech and the sample comparison speech to instruct a speech enhancement model to perform speech enhancement. For example, a minimum value of the duration threshold range may be 30 seconds, and the duration threshold range may be obtained through experimental computing based on an actual network training requirement. This is not limited herein.

In addition, speech content of the sample reference speech and the sample comparison speech may be different. For example, content of the sample reference speech and content of the sample comparison speech are two different pieces of news read by the same sound-producing object. The speech content may include as many words with different pronunciations as possible, so that the sample reference speech and the sample comparison speech cover more speech information, thereby improving accuracy and confidence of network training. Definitely, in another embodiment, speech content of the sample reference speech and the sample comparison speech in the same training sample may alternatively be the same.

In some embodiments, the sample reference speech, the sample comparison speech, and the interfering human voice may be randomly extracted from a speech database, and the ambient noise may be randomly extracted from a noise database. Further, the interfering human voice, the ambient noise, and the sample comparison speech are combined in different proportions to obtain the mixed speech, and the training sample includes the sample reference speech, the sample comparison speech, and the mixed speech. In this way, n training samples can be obtained, and then a training set {x⁰, x², . . . , xⁿ} including the n training samples is obtained, where n>0 & nϵN*. In some embodiments, the training set is stored to a database.

In an implementation, when training the speech enhancement network, the server may obtain the training set {x⁰, x², . . . , xⁿ} from the database.

Operation S120: Perform voiceprint extraction on the sample reference speech, to obtain a sample voiceprint vector.

In an implementation, the server may perform time-frequency conversion on the sample reference speech, to obtain a frequency domain feature of the sample reference speech. Further, the frequency domain feature of the sample reference speech is inputted into a voiceprint extraction network for voiceprint extraction, to obtain the sample voiceprint vector.

For example, after the sample reference speech is obtained, framing processing and windowing processing may be performed on the sample reference speech, and then time-frequency conversion is performed, to obtain the corresponding frequency domain feature. Specifically, framing processing and windowing processing are sequentially performed on the sample reference speech collected by a microphone, to obtain a speech signal frame of the sample reference speech; fast Fourier transformation (FFT) is performed on the speech signal frame, and a discrete power spectrum after the FFT is obtained; and then logarithmic computation is performed on the obtained discrete power spectrum, to obtain a logarithmic power spectrum as the frequency domain feature of the sample reference speech.

In some embodiments, the voiceprint extraction network may include a second long short-term memory sub-network, a second fully connected sub-network, and a pooling sub-network. Specifically, the frequency domain feature of the sample reference speech may be inputted into the second long short-term memory sub-network for feature extraction, to obtain a first voiceprint feature, and the first voiceprint feature is inputted into the second fully connected sub-network for full connection processing, to obtain a second voiceprint feature. Further, the second voiceprint feature may be inputted into the pooling sub-network for pooling processing, to obtain the sample voiceprint vector. It is worth mentioning that, a structure of the voiceprint extraction network is not limited to the foregoing examples. In another embodiment, the voiceprint feature extraction network may alternatively be constructed by using another neural network such as a convolutional neural network or a fully connected neural network. This is not limited herein.

Operation S130: Perform audio feature extraction on the mixed speech, to obtain a sample audio feature.

In some embodiments, the sample audio feature is an acoustic feature obtained based on mixed speech conversion, for example, a logarithmic power spectrum (LPS) and a mel-frequency cepstral coefficient (MFCC). This is not limited herein.

Speech data usually cannot be directly inputted to a model for training like image data, and has no significant feature change in long time domain. Therefore, it is very difficult to learn a feature of the speech data. In addition, time-domain data of a speech is usually sampled at a sampling rate of 16K, for example, there are 16,000 sampling points per second. Directly inputting time-domain sampling points causes an excessively large amount of training data, and makes it difficult to perform training with practical effectiveness. Therefore, in the speech enhancement task, the speech data may be converted into the acoustic feature as input or output of a network.

In an implementation, the server may perform framing processing, windowing processing, and fast Fourier transform on the mixed speech, to obtain the sample audio feature. In this way, the mixed speech is converted from a non-stationary time-varying signal in a time domain space into a stationary signal in a frequency domain space, thereby facilitating training of the speech enhancement network.

Operation S140: The speech enhancement network performs enhancement processing based on the sample voiceprint vector and the sample audio feature, to output a predicted audio feature for the sample sound-producing object. In other words, speech enhancement processing is performed on the sample voiceprint vector and the sample audio feature by using the speech enhancement network, to output the predicted audio feature for the sample sound-producing object.

In an actual application scenario, in addition to a speech of a target sound-producing object and the ambient noise, the speech collected by the microphone may further include an interfering human voice of another sound-producing object. To suppress both the ambient noise and the interfering human voice in the speech enhancement process, in the disclosure, the sample voiceprint vector of the sample sound-producing object is added to input of network training, to remove the ambient noise and the interfering human voice other than the speech of the sample sound-producing object.

The speech enhancement network performs speech enhancement processing based on the sample voiceprint vector and the sample audio feature, and outputs the predicted audio feature for the sample sound-producing object. The predicted audio feature may be considered as an audio feature of a speech after the interfering human voice and the ambient noise are suppressed for the mixed speech. In the disclosure, the sample voiceprint vector is inputted to the speech enhancement network, so that the speech enhancement network can be supervised to separate, from the sample audio feature based on the sample voiceprint vector, a feature related to the speech of the sample sound-producing object, to suppress features of the ambient noise and the interfering human voice in the sample audio feature, thereby performing speech enhancement on the mixed speech. In some embodiments, the sample voiceprint vector and the sample audio feature may be used as input of the speech enhancement network, and the predicted audio feature for the sample sound-producing object is outputted after processing by the speech enhancement network.

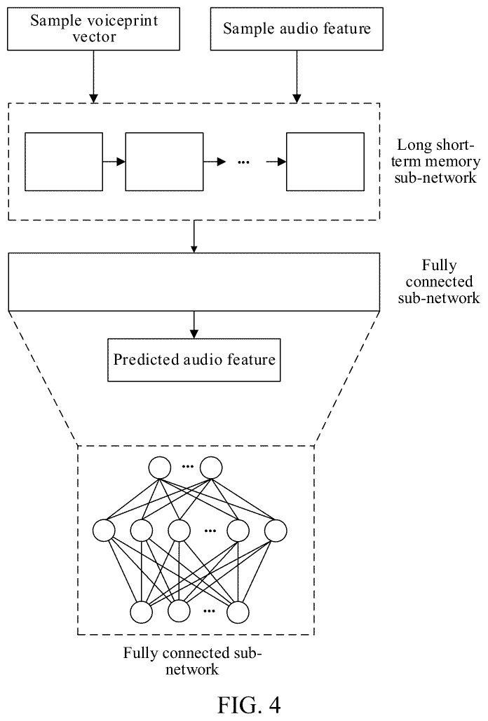

FIG. 4 is a schematic diagram of an architecture of a speech enhancement network according to some embodiments. The speech enhancement network may include a first long short-term memory sub-network (corresponding to a long short-term memory sub-network into which a sample voiceprint vector and a sample audio feature are inputted in FIG. 4) and a first fully connected sub-network (corresponding to a fully connected sub-network in FIG. 4). A quantity of layers in the first long short-term memory sub-network and a quantity of layers in the first fully connected sub-network may be set based on a training requirement. The speech feature forms a time series sequence with short-term stability, and matches with a long short-term memory capability of the long short-term memory network, thereby improving quality of speech enhancement. In some embodiments, the first long short-term memory sub-network may alternatively be a bi-directional long short-term memory (Bi-LSTM). This is not limited herein.

In an implementation, the server may input the sample voiceprint vector and the sample audio feature into the first long short-term memory sub-network for feature extraction, to obtain an intermediate feature. Further, the intermediate feature is inputted into the first fully connected sub-network for full connection processing, to obtain the predicted audio feature of the sample sound-producing object.

Operation S150: Determine a training loss value of the speech enhancement network based on the predicted audio feature and a comparison audio feature corresponding to the sample comparison speech. The training loss value may also be referred to as a target loss, and is a loss value of a target loss function.

The comparison audio feature corresponding to the sample comparison speech may be obtained by performing feature extraction on the sample comparison speech. In some embodiments, the comparison audio feature may be a frequency domain feature obtained by performing time-frequency conversion on the sample comparison speech, for example, the discrete power spectrum obtained by performing fast Fourier transform on the sample comparison speech.

In some embodiments, a learning objective for training the speech enhancement network is to make the predicted audio feature outputted by the speech enhancement network and the comparison audio feature corresponding to the sample comparison speech as close as possible in an embedding space, for example, enable the speech enhancement network to predict a predicted audio feature that is closer to a clean comparison audio feature as a label.

The training loss value is configured for measuring a difference between the predicted audio feature and the comparison audio feature corresponding to the sample comparison speech. A loss function configured for calculating the training loss value may be designed in a training process of the speech enhancement network. In the training process, a parameter of the speech enhancement network is continuously adjusted by using an optimization algorithm (for example, gradient descent), to complete training of the speech enhancement network with an aim of minimizing the training loss value outputted by the loss function.

In an implementation, a mean square error (MSE) between the predicted audio feature and the comparison audio feature corresponding to the sample comparison speech may be calculated as the training loss value of the speech enhancement network. A calculation formula is as follows:

$$Loss ( τ ) = {\sum }_{i = 0}^{n} mse ( {y}^{i} , {\hat{y}}^{i} )$$

where Loss(τ) represents the training loss value of the speech enhancement network, τ represents a weight parameter of the speech enhancement network, yⁱ represents a predicted audio feature corresponding to an i^{th} training sample (xⁱ, ŷⁱ), and ŷⁱ represents a comparison audio feature of a sample comparison speech corresponding to the i^{th} training sample.

In another embodiment, the training loss value of the speech enhancement network may alternatively be determined by using another loss function (such as a cross-entropy loss function or an absolute value loss function) based on the predicted audio feature and the comparison audio feature corresponding to the sample comparison speech. In some embodiments, a loss under each loss function may be calculated by using at least two different loss functions based on the predicted audio feature and the comparison audio feature corresponding to the sample comparison speech. Then, weighted processing is performed on losses under the at least two different loss functions, and a weighted processing result is used as the training loss value of the speech enhancement network.

Operation S160: Iteratively update the weight parameter of the speech enhancement network based on the training loss value until a training ending condition is satisfied.

In some embodiments, the training ending condition may include: the training loss value is less than a preset value, the training loss value no longer changes, a quantity of times of training reaches a preset quantity of times, or the like. In some embodiments, an optimizer may be used to optimize the target loss function, and a learning rate and a batch size during training and an epoch for training are set based on experimental experience. In the training process described in S110 to S150, the training loss value is obtained. If the obtained training loss value satisfies a training requirement, for example, the training loss value is less than the preset threshold, or the training loss value no longer changes or a change amplitude is small, it may be considered that training of the speech enhancement network in a current case is completed. If the training requirement is not satisfied, the weight parameter of the speech enhancement network is iteratively updated until the training ending condition is satisfied.

In an implementation, the iterative training is performed on the speech enhancement network for a plurality of training periods based on the training set. Each training period may include a plurality of times of iterative training. The weight parameter of the speech enhancement network is continuously optimized. The foregoing total loss value is increasingly smaller, and finally becomes smaller to a fixed value or is less than the foregoing preset value. In this case, it indicates that the speech enhancement network converges, an iterative update of the weight parameter of the speech enhancement network is stopped, and the network training is ended.

In some embodiments, when network training ends, the speech enhancement network obtained through training may be compared with an existing deep neural network configured for speech enhancement for speech enhancement performance. A noise mean option score (NMOS) may be used as a comparison indicator. A larger value of the NMOS indicates better speech enhancement performance.

In some embodiments, voiceprint extraction may be performed on the sample reference speech in the training sample, to obtain the sample voiceprint vector, and audio feature extraction may be performed on the mixed speech in the training sample, to obtain the sample audio feature. Further, the speech enhancement network performs enhancement processing based on the sample voiceprint vector and the sample audio feature, to output the predicted audio feature for the sample sound-producing object. Further, the training loss value of the speech enhancement network is determined based on the predicted audio feature and the comparison audio feature corresponding to the sample comparison speech, and the weight parameter of the speech enhancement network is iteratively updated based on the training loss value until the training ending condition is satisfied.

In this way, the sample voiceprint vector of the sample sound-producing object is added to input data of the speech enhancement network, so that the speech enhancement network improves learning attention on sound information of the sample sound-producing object in the training process, and the speech enhancement network focuses more on enhancing sound of the sample sound-producing object. In addition to removal of interfering noise, the speech enhancement network can effectively suppress the interfering human voice, so that the trained speech enhancement network can be configured to selectively enhance the speech of a specified sound-producing object, effectively suppress the ambient noise and the interfering noise, and improve quality and performance of speech enhancement.

In addition, in the speech enhancement network in the disclosure, the long short-term memory network and the fully connected network are used as a structure (Backbone), thereby effectively reducing time complexity and space complexity of an entire network structure, so that the speech enhancement network is more lightweight. In an actual application scenario of speech enhancement, consumption of computing resources and space resources can be reduced.

In some embodiments, after the training ends, the speech enhancement network may be deployed on a terminal. In this way, the terminal can perform speech enhancement on a collected speech (for example, in a voice call scenario, a video call scenario, or a cloud conference scenario) by using the speech enhancement network in real time, and transmit a speech signal after speech enhancement, so that a receiver plays the speech after speech enhancement, thereby improving a voice call effect. In addition, in some embodiments, the speech signal after speech enhancement instead of the directly collected speech is transmitted. In a case in which the directly collected speech includes at least one of an interfering human voice and ambient noise, an amount of data of the directly collected speech is larger than that of an enhanced speech. In this way, performing transmission after speech enhancement can effectively reduce an amount of transmitted data, reduce bandwidth consumption, and improve utilization of network resources.

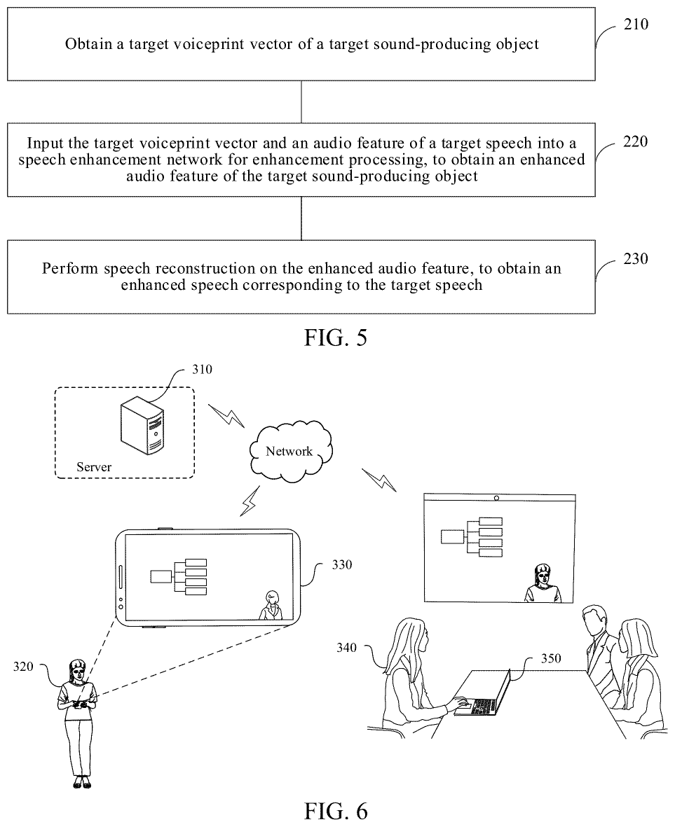

FIG. 5 is a schematic flowchart of a speech enhancement method according to some embodiments. In some embodiments, the speech enhancement network method may be performed by a terminal, and the terminal has at least display, storage, computing, and communication functions. The speech enhancement network used in the speech enhancement network method may be obtained through training by the server. The speech enhancement network method shown in FIG. 5 may be applied to a video conference scenario shown in FIG. 6.

In the video conferencing scenario, a cloud server 310 provided by a video conference service provider may be configured to train the speech enhancement network. After network training is completed, the user may download a video conference client with the speech enhancement network from the cloud server 310, and install the video conference client with the speech enhancement network on the terminal device, so that in a process of using the video conference, the terminal device may perform speech enhancement on a speech sound by using the speech enhancement network. The terminal device may include a first terminal device 330 and a second terminal device 350. The cloud server 310 is in communication connection with the first terminal device 330 and the second terminal device 350 through a network.

FIG. 6 is merely an application scenario diagram according to some embodiments. The application scenario described in some embodiments is intended to more clearly describe the technical solutions in some embodiments, and does not constitute a limitation on the technical solutions provided in some embodiments. A person of ordinary skill in the art may know that as a system architecture evolves and a new application scenario (such as online speech or live broadcast) emerges, the technical solutions provided in some embodiments are also applicable to resolving a similar technical problem. As shown in FIG. 5, the speech enhancement method may include the following operations:

Operation S210: Obtain a target voiceprint vector of a target sound-producing object.

The target sound-producing object refers to an object on which speech enhancement may be performed on a speech produced by the target sound-producing object. The target sound-producing object may also be a sound-producing object that is currently speaking. As shown in FIG. 6, in the video conference scenario, the user 340 is used as the target sound-producing object, for example, a current conference speaker.

In some embodiments, an account of the target sound-producing object in the client and the target voiceprint vector of the target sound-producing object may be associatively stored. In this way, after the client is logged in to, the target voiceprint vector of the target sound-producing object may be obtained based on the account of the client that is logged in to. For example, the target voiceprint vector of the target sound-producing object may be rapidly obtained based on an account used to log in to the video conference client.

In some other embodiments, before a voice call or a video call is performed, speech collection is performed on a participant of the call. The collected speech is used as an enrollment speech, and a voiceprint vector of a current participant of the call is extracted by using the enrollment speech. In this case, each participant of the call may be used as a target sound-producing object in the disclosure. In some embodiments, a voiceprint of each sound-producing object is determined by using an enrollment speech collected by a user during registration. This can trigger the sound-producing object to produce a more identifiable voice and obtain a more identifiable voiceprint, thereby facilitating subsequent comparison of voiceprints, and obtaining voiceprint vectors of different sound-producing objects.

In some scenarios, in consideration that, in the conference scenario, there is a possibility that a plurality of accounts in a conference may be used, or a video call or a voice call is performed between a plurality of users in a group, because a client to which one account is located includes a plurality of call participation objects, in this case, on each client, before a call starts, an enrollment speech of each call participation object may be collected, then voiceprint feature extraction is performed on the enrollment speech of each call participation object, and an extracted voiceprint vector is added to the voiceprint vector set. On the basis of this, operation S210 may include the following operation A1 to operation A3:

Operation A1: Perform voiceprint feature extraction on the target speech, to obtain a reference voiceprint vector.

The target speech is a currently collected speech on which speech enhancement is to be performed.

Operation A2: Calculate a voiceprint similarity between the reference voiceprint vector and each voiceprint vector in a voiceprint vector set.

Operation A3: Determine, in the voiceprint vector set based on the voiceprint similarity, a voiceprint vector having a highest similarity with the reference voiceprint vector and whose similarity with the reference voiceprint vector exceeds a similarity threshold, as the target voiceprint vector of the target sound-producing object.

The similarity threshold may be set based on an actual requirement. If a similarity between a voiceprint vector and a reference voiceprint vector exceeds the similarity threshold, it represents that there is a high probability that the voiceprint vector and the reference voiceprint vector are voiceprints of the same sound-producing object. In the disclosure, determining, in the voiceprint vector set, a voiceprint vector having a highest similarity with the reference voiceprint vector and whose similarity with the reference voiceprint vector exceeding a similarity threshold as the target voiceprint vector of the target sound-producing object is equivalent to determining, in the voiceprint vector set, a voiceprint vector that has a highest probability and corresponds to the same sound-producing object as the reference voiceprint vector as the target voiceprint vector of the target sound-producing object, for example, a target voiceprint vector of a sound-producing object from which a current to-be-enhanced target speech is from. In this way, from a voiceprint vector set including more accurate voiceprint vectors for the voiceprint objects, a target voiceprint vector that is more accurate than the currently collected voiceprint vector is determined, to facilitate subsequent more accurate speech enhancement.

In the foregoing embodiment, identity confirmation is performed on the target sound-producing object based on the target speech. For example, the second terminal device 350 may perform, in response to a collected target speech, speech recognition on the target speech, to determine an identity of the user 340, for example, whether the user 340 is an enrolled user, for example, a user from which a voiceprint vector in the voiceprint vector set is from.

In an implementation, a time interval between a moment when the target speech is captured and a previous speech on which speech enhancement is performed may be obtained. If the time interval is greater than an interval threshold, voiceprint feature extraction may be performed again for the current target speech, to match a target voiceprint vector configured for speech enhancement. If the time interval is not greater than the interval threshold, the target voiceprint vector of the target sound-producing object is directly obtained. In this way, when the time interval is greater than the interval threshold, for a case in which an existing sound-producing object changes, a corresponding target voiceprint vector can still be matched for a new sound-producing object.

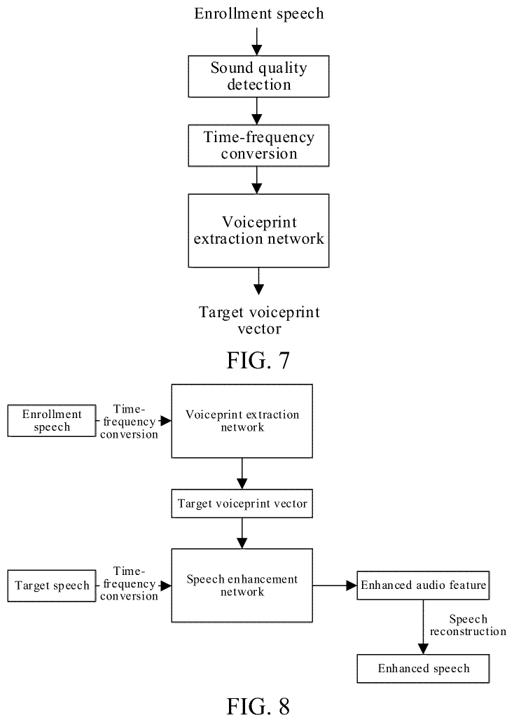

The target voiceprint vector may be pre-extracted and stored. In some embodiments, the enrollment speech of the target sound-producing object may be obtained, and voiceprint extraction is performed on the enrollment speech of the target sound-producing object, to obtain the target voiceprint vector of the target sound-producing object. FIG. 7 is a flowchart of extracting a target voiceprint vector. As shown in FIG. 7, the target sound-producing object may record a segment of speech, for example, an enrollment speech, and then perform sound quality detection on the enrollment speech.

For example, sound quality detection is performed on the enrollment speech, to obtain a speech signal-to-noise ratio of the enrollment speech. If the speech signal-to-noise ratio is greater than a signal-to-noise ratio threshold, time-frequency conversion may be performed on the enrollment speech, and further a frequency domain feature of the enrollment speech after time-frequency conversion is inputted into the voiceprint extraction network for voiceprint extraction, to obtain the target voiceprint vector of the target sound-producing object. Obtaining the target voiceprint vector of the target sound-producing object when the signal-to-noise ratio is large can represent the voiceprint feature of the sound-producing object more accurately, reduce interference from other sounds, and facilitate subsequent speech enhancement performed on the target sound-producing object based on the target voiceprint vector and the audio feature of the target speech, to obtain more accurate enhanced audio feature of the target sound-producing object.

In some embodiments, an enrolled user corresponding to an account used in a conference is not the same as the user 340. Therefore, a recorded speech of the target sound-producing object may be obtained. Further, voiceprint extraction is performed on the frequency domain feature of the recorded speech based on a voiceprint extraction network, to obtain the target voiceprint vector of the target sound-producing object.

For example, the second terminal device 350 may collect a segment of speech of the user 340, for example, record the speech. Further, voiceprint extraction is performed on the frequency domain feature of the recorded speech based on the voiceprint extraction network, to obtain the target voiceprint vector of the user 340.

Operation S220: Input the target voiceprint vector and an audio feature of a target speech into a speech enhancement network for enhancement processing, to obtain an enhanced audio feature of the target sound-producing object. In an implementation, the speech enhancement network may process the target voiceprint vector and the audio feature of the target speech, to suppress interference such as the ambient noise and the interfering human voice in the target speech, and the obtained enhanced audio feature of the target sound-producing object may be considered as an audio feature of a speech after interference such as the interfering human voice and the ambient noise is suppressed for the target speech.

For a training process of the speech enhancement network, reference may be made to content of operation 110 to operation 160 in the foregoing embodiments.

In an implementation, the speech enhancement network may include the long short-term memory sub-network and the fully connected sub-network. For example, the second terminal device 350 may input the target voiceprint vector of the user 340 and the collected audio feature of the target speech into the speech enhancement network. The second terminal device 350 may perform feature extraction on the target voiceprint vector and the collected audio feature of the target speech based on the long short-term memory sub-network of the speech enhancement network, to obtain the intermediate feature. Further, the second terminal device 350 may input the intermediate feature into the fully connected sub-network for full connection processing, to obtain the enhanced audio feature for the target sound-producing object.

Operation S230: Perform speech reconstruction on the enhanced audio feature, to obtain the enhanced speech corresponding to the target speech.

In an implementation, speech reconstruction may be performed on the obtained enhanced audio feature, the enhanced audio feature is converted from frequency domain into time domain, and an enhanced speech obtained after speech enhancement is calculated. For example, the second terminal device 350 may perform inverse Fourier transform on the enhanced audio feature, to obtain a time-domain speech after speech enhancement, for example, the enhanced speech. Further, the second terminal device 350 may send the enhanced speech to the first terminal device 330 by using the network, so that the user 320 may hear the enhanced speech played by the first terminal device 330.

For example, FIG. 8 is a flowchart of speech enhancement. As shown in FIG. 8, when obtaining the enrollment speech of the target sound-producing object, the terminal device may perform time-frequency conversion on the enrollment speech to obtain a corresponding frequency domain feature, and then perform voiceprint extraction on the frequency domain feature of the enrollment speech by using the voiceprint extraction network, to obtain the corresponding target voiceprint vector.

When collecting the target speech, the terminal device may input the frequency domain feature of the target speech after time-frequency conversion and the frequency domain feature of the enrollment speech into the speech enhancement network for speech enhancement, so that the speech enhancement network may output the enhanced audio feature for the target sound-producing object. Further, speech reconstruction, for example, inverse Fourier transform, is performed on the enhanced audio feature, to obtain an enhanced speech from which the interfering human voice and the interfering noise are removed for the target sound-producing object.

In consideration that a current target speech includes speeches of a plurality of main speakers, in this case, it is inconvenient to perform speech enhancement on the plurality of main speakers, and only the ambient noise can be suppressed. In some embodiments, the speech enhancement method may further include:
performing, if a similarity between a specified voiceprint vector in the voiceprint vector set and the reference voiceprint vector does not exceed the similarity threshold, speech enhancement on the target speech by using a reference speech enhancement network, to obtain a reference enhanced audio feature for the target speech, the reference speech enhancement network being obtained by training a noisy speech and a pure speech corresponding to the noisy speech; and the specified voiceprint vector being a voiceprint vector having a highest similarity with the reference voiceprint vector in the voiceprint vector set; and performing speech reconstruction on the reference enhanced audio feature, to obtain the enhanced speech corresponding to the target speech.

In some embodiments, the reference speech enhancement network may be obtained through training by using the following operations: obtaining a training sample set, the training sample set including a sample reference speech, a sample comparison speech, and interfering noise; separately performing audio feature extraction on the sample reference speech, the sample comparison speech, and the interfering noise, to obtain a corresponding reference audio feature, comparison audio feature, and noise audio feature; performing, by the reference speech enhancement network, enhancement processing based on the reference audio feature and the comparison audio feature, to output a predicted audio feature; determining a training loss value of the reference speech enhancement network based on the predicted audio feature and the comparison audio feature; and iteratively updating a weight parameter of the reference speech enhancement network based on the training loss value until a training ending condition is satisfied.

In the foregoing embodiment, two models for speech enhancement may be deployed in the application, for example, a speech enhancement network and a reference speech enhancement network. In a case that a voiceprint feature of the sound-producing object from which a current to-be-enhanced target speech is from can be determined, or in a case that the sound-producing object corresponding to the target speech is clear, speech enhancement is performed by using the speech enhancement network and based on the process shown in FIG. 6, to subsequently obtain an enhanced speech in which the interfering human voice and the ambient noise are removed. If the similarity between the specified voiceprint vector in the voiceprint vector set and the reference voiceprint vector does not exceed the similarity threshold, a possible reason is that the current target speech includes voices of a plurality of main sound-producing objects. In this case, speech enhancement may be performed on the target speech by using the reference speech enhancement network, thereby avoiding suppression of a voice of any main sound-producing object occurring in the target speech.

It is worth mentioning that, the foregoing speech enhancement method may be performed by a terminal, or may be performed by a server providing a speech service. This is not limited herein.

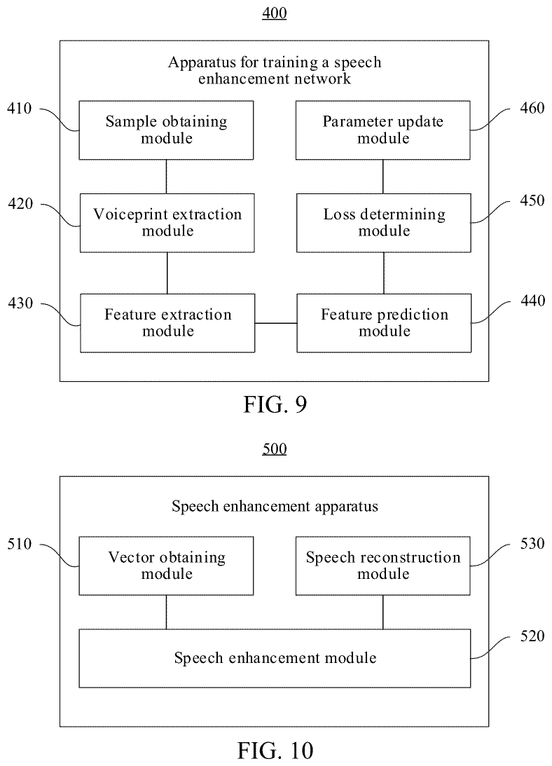

FIG. 9 is a structural block diagram of an apparatus 400 for training a speech enhancement network according to some embodiments. The apparatus 400 for training a speech enhancement network includes:
a sample obtaining module 410, configured to obtain a training set, the training set including a plurality of training samples, one training sample including a sample reference speech, a sample comparison speech, and a mixed speech, the mixed speech being obtained by mixing an interfering human voice, ambient noise, and the sample comparison speech; and the sample reference speech and the sample comparison speech in a same training sample being from a same sample sound-producing object;
a voiceprint extraction module 420, configured to perform voiceprint extraction on the sample reference speech, to obtain a sample voiceprint vector;
a feature extraction module 430, configured to perform audio feature extraction on the mixed speech, to obtain a sample audio feature;
a feature prediction module 440, configured to perform enhancement processing on the sample voiceprint vector and the sample audio feature by using the speech enhancement network, to output a predicted audio feature for the sample sound-producing object;
a loss determining module 450, configured to determine a training loss value of the speech enhancement network based on the predicted audio feature and a comparison audio feature corresponding to the sample comparison speech; and
a parameter update module 460, configured to iteratively update a weight parameter of the speech enhancement network based on the training loss value until a training ending condition is satisfied.

In some embodiments, the speech enhancement network includes a first long short-term memory sub-network and a first fully connected sub-network; and the feature prediction module 440 may be configured to:
input the sample voiceprint vector and the sample audio feature into the first long short-term memory sub-network for feature extraction, to obtain an intermediate feature; and
input the intermediate feature into the first fully connected sub-network for full connection processing, to obtain the predicted audio feature of the sample sound-producing object.

In some embodiments, the voiceprint extraction module 420 may include: a time-frequency conversion unit and a voiceprint extraction unit. The time-frequency conversion unit is configured to perform time-frequency conversion on the sample reference speech, to obtain a frequency domain feature of the sample reference speech; and the voiceprint extraction unit is configured to input the frequency domain feature of the sample reference speech into a voiceprint extraction network for voiceprint extraction, to obtain the sample voiceprint vector.

In some embodiments, the voiceprint extraction network includes a second long short-term memory sub-network, a second fully connected sub-network, and a pooling sub-network; and the voiceprint extraction unit may be configured to: input the frequency domain feature of the sample reference speech into the second long short-term memory sub-network for feature extraction, to obtain a first voiceprint feature; input the first voiceprint feature into the second fully connected sub-network for full connection processing, to obtain a second voiceprint feature; and input the second voiceprint feature into the pooling sub-network for pooling processing, to obtain the sample voiceprint vector.

A person skilled in the art may clearly understood that, for convenient and brief description, for a detailed working process of the foregoing described apparatus and module, reference may be made to a corresponding process in the foregoing method embodiments. Details are not described herein again.

In the several embodiments provided in the disclosure, mutual coupling between modules may be electrical, mechanical, or another form of coupling.

In addition, functional modules in some embodiments may be integrated into one processing module, or each of the modules may exist alone physically, or two or more modules may be integrated into one module. The foregoing integrated module may be implemented in a form of hardware, or may be implemented in a form of a software functional module.

In this way, the sample voiceprint vector of the sample sound-producing object is added to input data of the speech enhancement network, so that the speech enhancement network improves attention on learning sound information of the sample sound-producing object in a training process, and the speech enhancement network focuses more on enhancing sound of the sample sound-producing object. In addition to removal of interfering noise, an interfering human voice can also be effectively suppressed, thereby improving quality and performance of speech enhancement of a trained speech enhancement network.

FIG. 10 is a structural block diagram of a speech enhancement apparatus 500 according to some embodiments. The speech enhancement apparatus 500 includes:
a vector obtaining module 510, configured to obtain a target voiceprint vector of a target sound-producing object;
a speech enhancement module 520, configured to input the target voiceprint vector and an audio feature of a target speech into a speech enhancement network for enhancement processing, to obtain an enhanced audio feature for the target sound-producing object, the speech enhancement network being obtained through training by the apparatus 400 for training a speech enhancement network in the foregoing embodiment; and
a speech reconstruction module 530, configured to perform speech reconstruction on the enhanced audio feature, to obtain an enhanced speech corresponding to the target speech.

In some embodiments, the vector obtaining module 510 may be configured to: perform voiceprint feature extraction on the target speech, to obtain a reference voiceprint vector; calculate a voiceprint similarity between the reference voiceprint vector and each voiceprint vector in a voiceprint vector set; and determine, in the voiceprint vector set based on the voiceprint similarity, a voiceprint vector having a highest similarity with the reference voiceprint vector and whose similarity with the reference voiceprint vector exceeds a similarity threshold, as the target voiceprint vector of the target sound-producing object.

In some embodiments, the vector obtaining module 510 may further include: a voice obtaining unit, configured to obtain an enrollment speech of the target sound-producing object; and a vector generation unit, configured to perform voiceprint extraction on the enrollment speech of the target sound-producing object, to obtain the target voiceprint vector of the target sound-producing object.

In some embodiments, the vector generation module may be configured to: perform sound quality detection on the enrollment speech to obtain a speech signal-to-noise ratio of the enrollment speech; perform time-frequency conversion on the enrollment speech if the speech signal-to-noise ratio is greater than a signal-to-noise ratio threshold, to obtain a frequency domain feature of the enrollment speech; and perform voiceprint extraction on the frequency domain feature of the enrollment speech based on a voiceprint extraction network, to obtain the target voiceprint vector of the target sound-producing object.

In some embodiments, the vector obtaining module 510 may be further configured to: perform, if a similarity between a specified voiceprint vector in the voiceprint vector set and the reference voiceprint vector does not exceed the similarity threshold, speech augmentation on the target speech by using a reference speech enhancement network, to obtain a reference enhanced audio feature for the target speech, the reference speech enhancement network being obtained by training a noisy speech and a pure speech corresponding to the noisy speech; and the specified voiceprint vector being a voiceprint vector having a highest similarity with the reference voiceprint vector in the voiceprint vector set; and perform speech reconstruction on the reference enhanced audio feature, to obtain the enhanced speech corresponding to the target speech.

A person skilled in the art may clearly understand that, for convenient and brief description, for a detailed working process of the foregoing described apparatus and modules, reference may be made to a corresponding process in the foregoing method embodiments. Details are not described herein again.

In the several embodiments provided in the disclosure, mutual coupling between modules may be electrical, mechanical, or another form of coupling.

In addition, functional modules in some embodiments may be integrated into one processing module, or each of the modules may exist alone physically, or two or more modules may be integrated into one module. The foregoing integrated module may be implemented in a form of hardware, or may be implemented in a form of a software functional module.

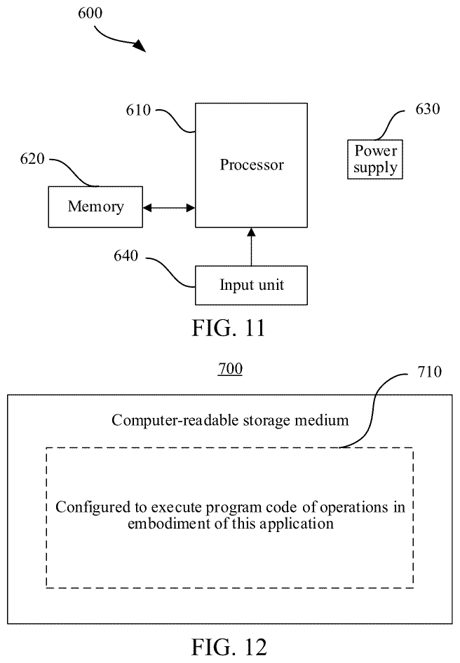

As shown in FIG. 11, some embodiments further provides a computer device 600. The computer device 600 includes a processor 610, a memory 620, a power supply 630, and an input unit 640. The memory 620 has a computer program stored therein. When the computer program is called by the processor 610, various method operations provided in the foregoing embodiments may be implemented. A person skilled in the art may understand that, the structure of the computer device shown in the figure does not constitute a limitation to the computer device. The computer device may include components that are more or fewer than those shown in the figure, or some components may be combined, or a different component deployment may be used.

The processor 610 may include one or more processing cores. The processor 610 connects various parts within an entire battery management system by using various interfaces and lines. By running or executing instructions, programs, instruction sets or program sets stored in the memory 620, and calling data stored in the memory 620, the processor 610 executes various functions and data processing of the battery management system, and executes various functions and data processing of the computer device, thereby performing overall control on the computer device. In some embodiments, the processor 610 may be implemented by using at least one hardware form of a digital signal processing (DSP), a field-programmable gate array (FPGA), and a programmable logic array (PLA). The processor 610 may integrate one or a combination of several of a central processing Unit (CPU) 610, a graphics processing unit (GPU) 610, a modem, and the like. The CPU processes an operating system, a user interface, an application program, and the like. The GPU is configured to be responsible for rendering and drawing of display content. The modem is configured to process wireless communication. The foregoing modem may not be integrated into the processor 610, and is separately implemented through a communication ship.

The memory 620 may include a random access memory (RAM) 620, or may include a read only memory (ROM) 620. The memory 620 may be configured to store instructions, programs, instruction sets or program sets. The memory 620 may include a program storage region and a data storage region. The program storage region may store instructions configured for implementing an operating system, instructions configured for implementing at least one function (for example, a touch function, a sound playback function, and an image playback function), instructions configured for implementing the foregoing various method embodiments, and the like. The data storage region may further store data (such as an address book and an audio and video data) created during use of the computer device. Correspondingly, the memory 620 may further include a memory controller, so that the processor 610 can access the memory 620.

The power supply 630 may be logically connected to the processor 610 by using a power management system, thereby implementing functions such as charging, discharging, and power consumption management by using the power management system. The power supply 630 may further include one or more direct current or alternating current power supplies, a re-charging system, a power failure detection circuit, a power supply converter or inverter, a power supply state indicator, and any other component.

The computer device may further include the input unit 640. The input unit 640 may be configured to receive input digit or character information and generate keyboard, mouse, joystick, optical, or trackball signal input related to user settings and function control.

Although not shown in the figure, the computer device 600 may further include a display unit, and the like. Details are not described herein again. Specifically, in some embodiments, the processor 610 in the computer device may load executable files corresponding to processes of one or more computer programs to the memory 620 according to the following instructions, and the processor 610 runs data such as an address book and an audio and video data stored in the memory 620, to implement various method operations provided in the foregoing embodiments.

As shown in FIG. 12, some embodiments further provides a computer-readable storage medium 700. The computer-readable storage medium 700 has a computer program 710 stored therein, and the computer program 710 can be called by a processor, to execute various method operations provided in some embodiments.

The computer-readable storage medium may be an electronic memory such as a flash memory, an electrically erasable programmable read-only memory (EEPROM), an EPROM, a hard disk, or a ROM. In some embodiments, the computer-readable storage medium includes a non-transitory computer-readable storage medium. The computer-readable storage medium 700 has storage space for a computer program that performs any method operation in the foregoing embodiments. These computer programs may be read from or written into one or more computer program products. The computer program can be compressed in a proper form.

According to some embodiments, a computer program product is provided. The computer program product includes a computer program, and the computer program is stored in a computer-readable storage medium. A processor of a computer device reads the computer program from the computer-readable storage medium, and the processor executes the computer program, to enable the computer device to execute various method operations in the foregoing embodiments.

The foregoing descriptions are merely exemplary embodiments of this disclosure, and are not intended to limit this disclosure in any form. Although this disclosure has been disclosed above through the exemplary embodiments, the embodiments are not intended to limit this disclosure. A person skilled in the art can make some variations or modifications to the technical content disclosed above without departing from the scope of the technical solutions of this disclosure, to obtain equivalent embodiments with equivalent changes. However, any simple alteration, equivalent change or modification made to the foregoing embodiments based on the technical essence of this disclosure without departing from the content of the technical solutions of this disclosure shall fall within the scope of the technical solutions of this disclosure.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A speech enhancement method, comprising:
obtaining a training set comprising a plurality of training samples, each of the plurality of training samples comprising a sample reference speech, a sample comparison speech, and a mixed speech obtained by mixing an interfering human voice, ambient noise, and the sample comparison speech,
wherein the sample reference speech and the sample comparison speech in a same training sample are from a same sample sound-producing object;
extracting a sample voiceprint vector based on the sample reference speech;
extracting a sample audio feature based on the mixed speech;
performing, based on a speech enhancement network, speech enhancement processing on the sample voiceprint vector and the sample audio feature;
outputting a predicted audio feature for the sample sound-producing object based on the speech enhancement processing;
determining a training loss value of the speech enhancement network based on the predicted audio feature and a comparison audio feature corresponding to the sample comparison speech; and
updating iteratively a weight parameter of the speech enhancement network based on the training loss value until a training ending condition is satisfied.

2. The method according to claim 1,
wherein the speech enhancement network comprises: a first long short-term memory sub-network and a first fully connected sub-network,
wherein the performing speech enhancement processing comprises:
inputting the sample voiceprint vector and the sample audio feature into the first long short-term memory sub-network to extract an intermediate feature; and
inputting the intermediate feature into the first fully connected sub-network to obtain the predicted audio feature of the sample sound-producing object.

3. The method according to claim 1, wherein the extracting a sample voiceprint vector comprises:
performing time-frequency conversion on the sample reference speech, to obtain a frequency domain feature of the sample reference speech; and
inputting the frequency domain feature of the sample reference speech into a voiceprint extraction network for voiceprint extraction, to obtain the sample voiceprint vector.

4. The method according to claim 3,
wherein the voiceprint extraction network comprises a second long short-term memory sub-network, a second fully connected sub-network, and a pooling sub-network; and
wherein the inputting the frequency domain feature comprises:
inputting the frequency domain feature of the sample reference speech into the second long short-term memory sub-network to extract a first voiceprint feature;
inputting the first voiceprint feature into the second fully connected sub-network to obtain a second voiceprint feature; and
inputting the second voiceprint feature into the pooling sub-network for pooling processing, to obtain the sample voiceprint vector.

5. The method according to claim 1, further comprising:
obtaining a target voiceprint vector of a target sound-producing object;
inputting the target voiceprint vector and an audio feature of a target speech into the speech enhancement network;
obtaining an enhanced audio feature for the target sound-producing object; and
performing speech reconstruction on the enhanced audio feature; and
obtaining an enhanced speech corresponding to the target speech based on the speech reconstruction.

6. The method according to claim 5, wherein the obtaining a target voiceprint vector comprises:
extracting a reference voiceprint vector based on the target speech;
calculating a voiceprint similarity between the reference voiceprint vector and each voiceprint vector in a voiceprint vector set; and
determining, from the voiceprint vector set based on the voiceprint similarity, a voiceprint vector having a highest similarity with the reference voiceprint vector and whose similarity with the reference voiceprint vector exceeds a similarity threshold, as the target voiceprint vector of the target sound-producing object.

7. The method according to claim 5, wherein before the obtaining a target voiceprint vector, the method further comprises:
obtaining enrollment speech of the target sound-producing object; and
performing voiceprint extraction on the enrollment speech of the target sound-producing object.

8. The method according to claim 7, wherein the performing voiceprint extraction on the enrollment speech of the target sound-producing object comprises:
performing sound quality detection on the enrollment speech;
obtaining a speech signal-to-noise ratio of the enrollment speech based on the sound quality detection;
performing time-frequency conversion on the enrollment speech based on the speech signal-to-noise ratio being greater than a signal-to-noise ratio threshold;
obtaining a frequency domain feature of the enrollment speech based on the time-frequency conversion; and
performing voiceprint extraction on the frequency domain feature of the enrollment speech based on a voiceprint extraction network.

9. The method according to claim 5, further comprising:
performing, based on a similarity between a specified voiceprint vector in the voiceprint vector set and the reference voiceprint vector not exceeding the similarity threshold, speech enhancement on the target speech by using a reference speech enhancement network,
wherein the reference speech enhancement network being obtained based on training a noisy speech and a pure speech corresponding to the noisy speech, the specified voiceprint vector has a highest similarity with the reference voiceprint vector in the voiceprint vector set;
obtaining a reference enhanced audio feature for the target speech based on the speech enhancement on the target speech;
performing speech reconstruction on the reference enhanced audio feature; and
obtaining the enhanced speech corresponding to the target speech based on the speech reconstruction.

10. A speech enhancement apparatus, comprising:
at least one memory configured to store program code; and
at least one processor configured to read the program code and operate as instructed by the program code, the program code comprising:
obtaining code configured to cause at least one of the at least one processor to obtain a training set comprising a plurality of training samples, each of the plurality of training samples comprising a sample reference speech, a sample comparison speech, and a mixed speech obtained by mixing an interfering human voice, ambient noise, and the sample comparison speech,
wherein the sample reference speech and the sample comparison speech in a same training sample are from a same sample sound-producing object;
voiceprint code configured to cause at least one of the at least one processor to extract a sample voiceprint vector based on the sample reference speech;
audio code configured to cause at least one of the at least one processor to extract a sample audio feature based on the mixed speech;
processing code configured to cause at least one of the at least one processor to perform, based on a speech enhancement network, speech enhancement processing on the sample voiceprint vector and the sample audio feature;
outputting code configured to cause at least one of the at least one processor to output a predicted audio feature for the sample sound-producing object based on the speech enhancement processing;
determining code configured to cause at least one of the at least one processor to determine a training loss value of the speech enhancement network based on the predicted audio feature and a comparison audio feature corresponding to the sample comparison speech; and
updating code configured to cause at least one of the at least one processor to update iteratively a weight parameter of the speech enhancement network based on the training loss value until a training ending condition is satisfied.

11. The apparatus according to claim 10,
wherein the speech enhancement network comprises: a first long short-term memory sub-network and a first fully connected sub-network,
wherein the processing code is further configured to cause at least one of the at least one processor to:
input the sample voiceprint vector and the sample audio feature into the first long short-term memory sub-network to extract an intermediate feature; and
input the intermediate feature into the first fully connected sub-network to obtain the predicted audio feature of the sample sound-producing object.

12. The apparatus according to claim 10, wherein the voiceprint code is further configured to cause at least one of the at least one processor to:
perform time-frequency conversion on the sample reference speech, to obtain a frequency domain feature of the sample reference speech; and
input the frequency domain feature of the sample reference speech into a voiceprint extraction network for voiceprint extraction, to obtain the sample voiceprint vector.

13. The apparatus according to claim 12,
wherein the voiceprint extraction network comprises a second long short-term memory sub-network, a second fully connected sub-network, and a pooling sub-network; and
wherein the voiceprint code is further configured to cause at least one of the at least one processor to:
input the frequency domain feature of the sample reference speech into the second long short-term memory sub-network to extract a first voiceprint feature;
input the first voiceprint feature into the second fully connected sub-network to obtain a second voiceprint feature; and
input the second voiceprint feature into the pooling sub-network for pooling processing, to obtain the sample voiceprint vector.

14. The apparatus according to claim 10, wherein the program code further comprises:
target code configured to cause at least one of the at least one processor to obtain a target voiceprint vector of a target sound-producing object;
input code configured to cause at least one of the at least one processor to input the target voiceprint vector and an audio feature of a target speech into the speech enhancement network;
enhancement code configured to cause at least one of the at least one processor to obtain an enhanced audio feature for the target sound-producing object; and
reconstruction code configured to cause at least one of the at least one processor to perform speech reconstruction on the enhanced audio feature; and
obtaining code configured to cause at least one of the at least one processor to obtain an enhanced speech corresponding to the target speech based on the speech reconstruction.

15. The apparatus according to claim 14, wherein the target code is further configured to cause at least one of the at least one processor to:
extract a reference voiceprint vector based on the target speech;
calculate a voiceprint similarity between the reference voiceprint vector and each voiceprint vector in a voiceprint vector set; and
determine, from the voiceprint vector set based on the voiceprint similarity, a voiceprint vector having a highest similarity with the reference voiceprint vector and whose similarity with the reference voiceprint vector exceeds a similarity threshold, as the target voiceprint vector of the target sound-producing object.

16. The apparatus according to claim 14, wherein the program code further comprises:
enrollment code configured to cause at least one of the at least one processor to obtain enrollment speech of the target sound-producing object; and
extraction code configured to cause at least one of the at least one processor to perform voiceprint extraction on the enrollment speech of the target sound-producing object.

17. The apparatus according to claim 16, wherein the extraction code is further configured to cause at least one of the at least one processor to:
perform sound quality detection on the enrollment speech;
obtain a speech signal-to-noise ratio of the enrollment speech based on the sound quality detection;
perform time-frequency conversion on the enrollment speech based on the speech signal-to-noise ratio being greater than a signal-to-noise ratio threshold;
obtain a frequency domain feature of the enrollment speech based on the time-frequency conversion; and
perform voiceprint extraction on the frequency domain feature of the enrollment speech based on a voiceprint extraction network.

18. The apparatus according to claim 14, wherein the program code further comprises:
reference code configured to cause at least one of the at least one processor to perform, based on a similarity between a specified voiceprint vector in the voiceprint vector set and the reference voiceprint vector not exceeding the similarity threshold, speech enhancement on the target speech by using a reference speech enhancement network,
wherein the reference speech enhancement network being obtained based on training a noisy speech and a pure speech corresponding to the noisy speech, the specified voiceprint vector has a highest similarity with the reference voiceprint vector in the voiceprint vector set;
wherein the reference code is further configured to cause at least one of the at least one processor to obtain a reference enhanced audio feature for the target speech based on the speech enhancement on the target speech;
wherein the reconstruction code is further configured to cause at least one of the at least one processor to perform speech reconstruction on the reference enhanced audio feature; and
wherein the obtaining code is further configured to cause at least one of the at least one processor to obtain the enhanced speech corresponding to the target speech based on the speech reconstruction.

19. A non-transitory computer-readable storage medium, storing computer code which, when executed by at least one processor, causes the at least one processor to at least:
obtain a training set comprising a plurality of training samples, each of the plurality of training samples comprising a sample reference speech, a sample comparison speech, and a mixed speech obtained by mixing an interfering human voice, ambient noise, and the sample comparison speech,
wherein the sample reference speech and the sample comparison speech in a same training sample are from a same sample sound-producing object;
extract a sample voiceprint vector based on the sample reference speech;
extract a sample audio feature based on the mixed speech;
perform, based on a speech enhancement network, speech enhancement processing on the sample voiceprint vector and the sample audio feature;
output a predicted audio feature for the sample sound-producing object based on the speech enhancement processing;
determine a training loss value of the speech enhancement network based on the predicted audio feature and a comparison audio feature corresponding to the sample comparison speech; and
update iteratively a weight parameter of the speech enhancement network based on the training loss value until a training ending condition is satisfied.
